(19) United States
(12) Patent Application Publication
(10) Pub. No.: US 2024/0312313 A1
(43) Pub. Date: Sep. 19, 2024

(54) SERVICE PROVIDING SERVER FOR PROVIDING A GAME SERVICE THAT SUPPORTS PARTICIPATION IN A TOURNAMENT FOR A GAME USING A TICKET AND ENABLES MATCH PREDICTION AND BETTING ON MEMBERS PARTICIPATING IN THE TOURNAMENT AND THE OPERATING METHOD THEREOF

(71) Applicant: Supertree Co., Ltd., Seoul (KR)

(72) Inventor: Sung Wone CHOI, Seoul (KR)

(73) Assignee: Supertree Co., Ltd., Seoul (KR)

(21) Appl. No.: 18/604,390

(22) Filed: Mar. 13, 2024

(30) Foreign Application Priority Data
Mar. 15, 2023 (KR) 10-2023-0033712

(51) Int. Cl. G07F 17/32; G06Q 20/36; G06Q 50/34

(52) U.S. Cl. CPC G07F 17/3288; G06Q 20/36; G06Q 50/34; G07F 17/3223; G07F 17/3237; G07F 17/3279

(57) ABSTRACT

Disclosed are a service providing server for providing a game service that supports participation in a tournament for a game using a ticket and enables match prediction and betting on members participating in the tournament and the operating method thereof, which allow members to enjoy the games together with other members in an online environment while competing with each other in a tournament scheme, and at the same time, provide match prediction information for members who participate in the tournament, and enable betting based on the provided match prediction information to support even members who do not participate in the tournament to enjoy the game service together.

### CROSS-REFERENCE TO RELATED APPLICATIONS

This application claims priority to and the benefit of Korean Patent Application No. 10-2023-0033712 filed in the Korean Intellectual Property Office on Mar. 15, 2023, the entire contents of which are incorporated herein by reference.

### TECHNICAL FIELD

The present disclosure relates to a service providing server for providing a game service that supports participation in a tournament for a game using a ticket and enables match prediction and betting on members participating in the tournament and the operating method thereof.

### BACKGROUND ART

Recently, as various electronic terminals including desktop PCs, smart phones, tablet PCs, console game machines, etc., have been released, the number of persons who play games through the electronic terminals has increased.

In particular, the recent electronic terminals provide an environment which enables playing games with others online, in that the electronic terminals enable online connections, and as such an environment is widely distributed, an interest in introduction of a new business model using an online based game is also increasing.

For example, by holding a tournament competition using a number of games so that people participate in the tournament of the game they want, the introduction of a business model that pays a certain reward to the winner who wins a specific tournament competition can be considered.

However, in order to provide a tournament platform service using these games, user management technology needs to be introduced, which allows anybody not to participate in the tournament, but allows only the users who qualify for participating in a predetermined tournament to participate in the tournament to improve the quality of the service.

In addition, in order to entice people's interest in the service, a technology needs to be introduced, in which a betting session to bet on tournament participants is opened to allow even persons who do not participate in the tournament to participate in the betting to enjoy the service together, and in this case, match prediction information for tournament participants is provided to allow the tournament participants who does not participate in the tournament to predict a match the corresponding tournament based on the match prediction information, and if the tournament participants who do not participate in the tournament succeed in the betting, a predetermined reward is paid to cause the interest in the tournament.

In this regard, the introduction of service technology can be considered, which allows only predetermined certified members to participate in the tournament, and at the same time, issues a predetermined ticket for participating in the tournament, and allows only the people who purchase this ticket to participate in the tournament of a specific game and allows betting on the corresponding tournament based on the match prediction information for the member who participates in the tournament.

### SUMMARY OF THE INVENTION

The present disclosure has been made in an effort to provide service providing server for providing a game service that supports participation in a tournament for a game using a ticket and enables match prediction and betting on members participating in the tournament and the operating method thereof which allow members to enjoy the games together with other members in an online environment while competing with each other in a tournament scheme, and at the same time, provide match prediction information for members who participate in the tournament, and enable betting based on the provided match prediction information to support even members who do not participate in the tournament to enjoy the game service together.

An exemplary embodiment of the present disclosure provides a service providing server for providing a game service that supports participation in a tournament for a game using a ticket and enables match prediction and betting on members participating in the tournament, which includes: a game information storage unit storing information on the number of required tickets for participating in tournaments of a plurality of predetermined respective games; a ticket information storage unit storing information on the quantity of holding tickets held by each of a plurality of members which subscribes to the game service; a wallet address storage unit storing information on a wallet address for accumulating cryptocurrency held by each of the plurality of members; a record information storage unit storing record information of each of the plurality of members for each of the plurality of games, wherein the record information for each of the plurality of games is information in which victory/defeat records in the battle for each of the plurality of games of each member are divided and recorded for each game; a confirmation unit conducting, when an access request instruction to a tournament session, wherein the tournament session means a session opened for allowing members accessing to the tournament session through the electronic terminal to play the first game online jointly, opened for a first game which is any one of the plurality of games is received from a first electronic terminal of a first member which is any one of the plurality of members, certification for the first member, and then confirming a first required number which is the number of required tickets for participating in the tournament of the first game by referring to the game information storage unit, and confirming the quantity of holding tickets held by the first member by referring to the ticket information storage unit; a reduction processing unit allowing, when it is confirmed that the quantity of holding tickets held by the first member is equal to or more than the first required number, the first electronic terminal to access the tournament session, and then reducing the quantity of holding tickets for the first member stored in the ticket information storage unit by the first required number; an opening unit opening, after the access of the first electronic terminal to the tournament session is allowed, when there is a situation in which the first member is matched with a second member who accesses the tournament session to perform a battle for the first game, a betting session for betting on a member who is predicted to win the game between the first member and the second member; an information transmission unit confirming, when a providing request instruction for requesting providing match prediction information in a battle for the first game is received from electronic terminals of a plurality of betting participation members who access the betting session among the plurality of members after the betting session is opened, record information of each of the first member and the second member for the first game by referring to the record information storage unit, and then computing a winning rate of each of the first member and the second member for the first game, and generating the match prediction information based on the winning rate of each of the first member and the second member for the first game, and transmitting the generated match prediction information to the electronic terminals of the plurality of betting participation members; a table generation unit generating, when the match prediction information is transmitted to the electronic terminals of the plurality of betting participation members, and then a betting request instruction for any one member of the first member and the second member is received from the electronic terminals of the plurality of betting participation members, a betting table in which selection information for a member which each of the plurality of betting participation members selects as a betting target is recorded; and a reward processing unit confirming, after the betting table is generated, when it is determined that the first member wins as a result of performing the battle for the first game, first betting members who bets on the first member among the plurality of betting participation members by referring to the betting table, and then confirming a wallet address of each of the first betting members by referring to the wallet address storage unit, and transferring cryptocurrency corresponding to a predetermined dividend payment amount to the wallet address of each of the first betting members to complete reward processing for the first betting members, and confirming, when it is determined that the second member wins, second betting members who bets on the second member among the plurality of betting participation members by referring to the betting table, and then a wallet address of each of second betting members who bet on the second member among the plurality of betting participation members is confirmed by referring to the wallet address storage unit, and then transferring cryptocurrency of the dividend payment amount to the wallet address of each of the second betting members to complete reward processing for the second betting members.

Further, another exemplary embodiment of the present disclosure provides an operating method of a service providing server for providing a game service that supports participation in a tournament for a game using a ticket and enables match prediction and betting on members participating in the tournament, which includes: maintaining a game information storage unit storing information on the number of required tickets for participating in tournaments of a plurality of predetermined respective games; maintaining a ticket information storage unit storing information on the quantity of holding tickets held by each of a plurality of members which subscribes in the game service; maintaining a wallet address storage unit storing information on a wallet address for accumulating cryptocurrency held by each of the plurality of members; maintaining a record information storage unit storing record information of each of the plurality of members for each of the plurality of games, wherein the record information for each of the plurality of games is information in which victory/defeat records in the match for each of the plurality of games of each member are divided and recorded for each game; conducting, when an access request instruction to a tournament session, wherein the tournament session means a session opened for allowing members accessing to the tournament session through the electronic terminal to play the first game online jointly, opened for a first game which is any one of the plurality of games is received from a first electronic terminal of a first member which is any one of the plurality of members, certification for the first member, and then confirming a first required number which is the number of required tickets for participating in the tournament of the first game by referring to the game information storage unit, and confirming the quantity of holding tickets held by the first member by referring to the ticket information storage unit; allowing, when it is confirmed that the quantity of holding tickets held by the first member is equal to or more than the first required number, the first electronic terminal to access the tournament session, and then reducing the quantity of holding tickets for the first member stored in the ticket information storage unit by the first required number; opening, after the access of the first electronic terminal to the tournament session is allowed, when there is a situation in which the first member is matched with a second member who accesses the tournament session to perform a battle for the first game, a betting session for betting on a member who is predicted to win the game between the first member and the second member; confirming, when a providing request instruction for requesting providing match prediction information in a battle for the first game is received from electronic terminals of a plurality of betting participation members who access the betting session among the plurality of members after the betting session is opened, record information of each of the first member and the second member for the first game by referring to the record information storage unit, and then computing a winning rate of each of the first member and the second member for the first game, and generating the match prediction information based on the winning rate of each of the first member and the second member for the first game, and transmitting the generated match prediction information to the electronic terminals of the plurality of betting participation members; generating, when the match prediction information is transmitted to the electronic terminals of the plurality of betting participation members, and then a betting request instruction for any one member of the first member and the second member is received from the electronic terminals of the plurality of betting participation members, a betting table in which selection information for a member which each of the plurality of betting participation members selects as a betting target is recorded; and confirming, after the betting table is generated, when it is determined that the first member wins as a result of performing the battle for the first game, first betting members who bets on the first member among the plurality of betting participation members by referring to the betting table, and then confirming a wallet address of each of the first betting members by referring to the wallet address storage unit, and transferring cryptocurrency corresponding to a predetermined dividend payment amount to the wallet address of each of the first betting members to complete reward processing for the first betting members, and confirming, when it is determined that the second member wins, second betting members who bets on the second member among the plurality of betting participation members by referring to the betting table, and then a wallet address of each of second betting members who bet on the second member among the plurality of betting participation members is confirmed by referring to the wallet address storage unit, and then transferring cryptocurrency of the dividend payment amount to the wallet address of each of the second betting members to complete reward processing for the second betting members.

A service providing server for providing a game service that supports participation in a tournament for a game using a ticket and enables match prediction and betting on members participating in the tournament and the operating method thereof are provided, which allow members to enjoy the games together with other members in an online environment while competing with each other in a tournament scheme, and at the same time, provide match prediction information for members who participate in the tournament, and enable betting based on the provided match prediction information to support even members who do not participate in the tournament to enjoy the game service together.

### BRIEF DESCRIPTION OF THE DRAWINGS

FIG. 1 is a diagram illustrating a structure of a service providing server for providing a game service that supports participation in a tournament for a game using a ticket and enables match prediction and betting on members participating in the tournament according to an exemplary embodiment of the present disclosure.

FIG. 2 is a diagram describing an operation of a service providing server for providing a game service that supports participation in a tournament for a game using a ticket and enables match prediction and betting on members participating in the tournament according to an exemplary embodiment of the present disclosure.

FIG. 3 is a flowchart illustrating an operating method of a service providing server for providing a game service that supports participation in a tournament for a game using a ticket and enables match prediction and betting on members participating in the tournament according to an exemplary embodiment of the present disclosure.

### DETAILED DESCRIPTION

Hereinafter, exemplary embodiments of the present disclosure will be described in detail with reference to the accompanying drawings. The description does not limit the present disclosure to specific exemplary embodiments, and it should be understood that the present disclosure covers all the modifications, equivalents and replacements included within the idea and technical scope of the present disclosure. In describing each drawing, like reference numerals refer to like elements and if not contrarily defined, all terms used herein including technological or scientific terms have the same meanings as those generally understood by a person with ordinary skill in the art.

In this document, unless explicitly described to the contrary, the word “comprise” and variations such as “comprises” or “comprising”, will be understood to imply the inclusion of stated elements but not the exclusion of any other elements. Further, in various exemplary embodiments of the present disclosure, each of the components, functional blocks or means may be constituted by one or more lower components and electrical, electronic, and mechanical functions performed by respective components may be implemented as various known devices or mechanical elements including an electronic circuit, an integrated circuit, an Application Specific Integrated Circuit (ASIC), etc., and the respective components may be separately implemented or two or more components may be integrated into one and implemented.

Meanwhile, blocks of the accompanying block diagram or steps of a flowchart may be appreciated as meaning compute program instructions mounted on a processor or a memory of data processible equipment such as a universal computer, a special computer, a portable notebook computer, a network computer, etc., and performing designated functions. Since the computer program instructions may be stored in a memory provided in a computer device or a computer readable memory, functions described in blocks of a block diagram or steps of a flowchart may be produced as a manufactured object including an instruction mean performing the functions. Moreover, each block or each step may represent a part of a module, a segment, or a code that includes one or more executable instructions for executing a specified logical function(s). It should also be noted that in some replaceable embodiments, the functions mentioned in the blocks or steps may also be executed differently from a predetermined order. For example, two blocks or steps that are subsequently illustrated are substantially simultaneously carried out, or may be performed in a reverse order, and in some cases, the functions may be performed while some blocks or steps are omitted.

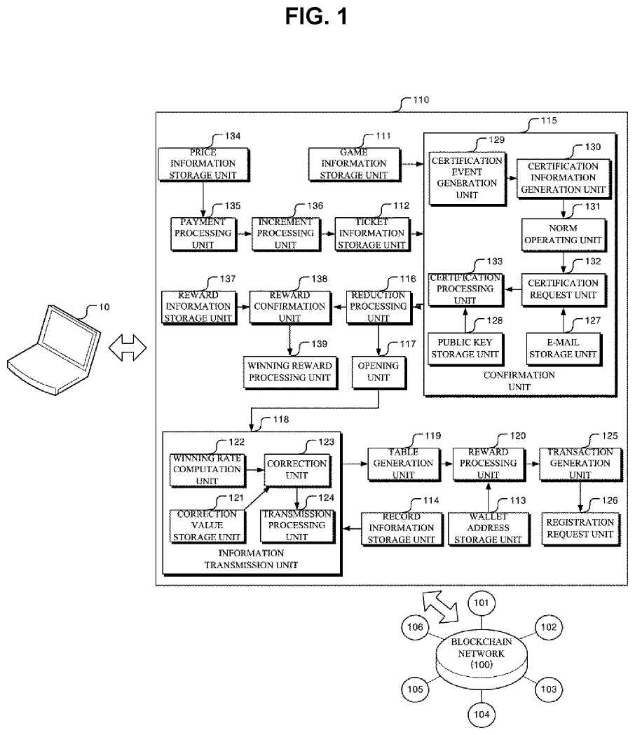

FIG. 1 is a diagram illustrating a structure of a service providing server for providing a game service that supports participation in a tournament for a game using a ticket and enables match prediction and betting on members participating in the tournament according to an exemplary embodiment of the present disclosure.

Referring to FIG. 1, the service providing server 110 according to the present disclosure may include a game information storage unit 111, a ticket information storage unit 112, a wallet address storage unit 113, a record information storage unit 114, a confirmation unit 115, a reduction processing unit 116, an opening unit 117, an information transmission unit 118, a table generation unit 119, and a reward processing unit 120.

The game information storage unit 111 stores information on the number of required tickets for participating in tournaments of a plurality of predetermined respective games.

For example, the game information storage unit 111 may store information shown in Table 1 below.

TABLE 1

| Plurality of games | Number of required tickets |
|---|---|
| Game 1 | 2 |
| Game 2 | 1 |
| Game 3 | 5 |
| Game 4 | 7 |
| . . . | . . . |

The ticket information storage unit 112 stores information on the quantity of holding tickets held by each of a plurality of members which subscribes to the game service.

For example, the ticket information storage unit 112 may store information shown in Table 2 below.

TABLE 2

| Plurality of members | Quantity of holding tickets |
|---|---|
| Member 1 | 10 |
| Member 2 | 30 |
| Member 3 | 0 |
| Member 4 | 5 |
| . . . | . . . |

The wallet address storage unit 113 stores information on a wallet address for accumulating cryptocurrency held by each of the plurality of members.

For example, the wallet address storage unit 113 may store information as in Table 3 below.

TABLE 3

| Plurality of members | Wallet address |
|---|---|
| Member 1 | Address 1 |
| Member 2 | Address 2 |
| Member 3 | Address 3 |
| Member 4 | Address 4 |
| . . . | . . . |

The record information storage unit 114 stores record information of each of the plurality of members for each of the plurality of games (the record information for each of the plurality of games is information in which winning/losing records in the match for each of the plurality of games of each member are divided and recorded for each game).

For example, the record information storage unit 114 may store information shown in Table 4 below.

TABLE 4

| Plurality | | | | | |
|---|---|---|---|---|---|
| of | Record information | | | | |
| members | Game 1 | Game 2 | Game 3 | Game 4 | . . . |
| Member 1 | 3 wins 0 | 10 wins 7 | 4 wins 8 | 17 wins 6 | . . . |
| | loss | losses | losses | losses | |
| Member 2 | 50 wins 25 | 30 wins 20 | 60 wins 40 | 30 wins 10 | . . . |
| | losses | losses | losses | losses | |
| Member 3 | 21 wins 20 | 30 wins 30 | 25 wins 35 | 13 wins 15 | . . . |
| | losses | losses | losses | losses | |
| Member 4 | 70 wins 15 | 72 wins 18 | 85 wins 20 | 90 wins 30 | . . . |
| | losses | losses | losses | losses | |
| . . . | . . . | . . . | . . . | . . . | . . . |

In such a situation, an operator of the service providing server 110 according to the present disclosure may hold a tournament competition for each of the plurality of games in order to provide the game service, and in this case, the operator may open a tournament session of each of the plurality of games online in order to allow the members to participate in the tournament competition for each of the plurality of games online through electronic terminals held by the members.

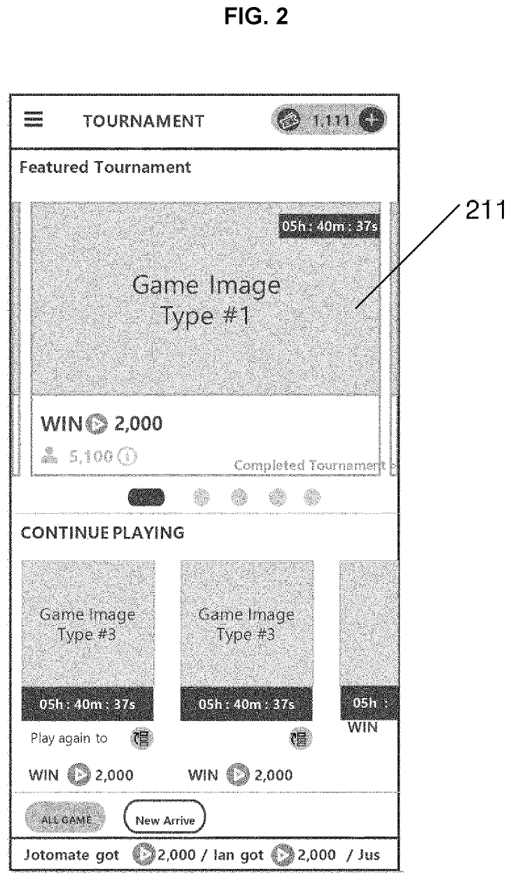

In this regard, FIG. 2 is a diagram illustrating an example of a screen in which when a specific member accesses the service providing server 110 through an electronic terminal thereof, a tournament session of each of the plurality of games is opened, which may be viewed through the electronic terminal. Here, when reference numeral 211 of FIG. 2 represents a screen in which a tournament session for a first game which is any one of the plurality of games is opened, the tournament session means a session opened so as for members who accesses the tournament session to play the first game online jointly through the electronic terminal. That is, multiple members access the tournament session through electronic terminals thereof to play the first game jointly with each other online.

As a result, when a first member which is any one of the plurality of members accesses the service providing server 110 through a first electronic terminal 10 thereof, the first member may view a waiting room screen having a UI shown in FIG. 2 through the first electronic terminal 10.

In this case, when the first member clicks on the tournament session for the first game represented by reference numeral 211 through the first electronic terminal 10, the first electronic terminal 10 may transmit, to the service providing server 110 of the present disclosure, an access request instruction to the tournament session.

In this case, when the confirmation unit 115 receives, from the first electronic terminal 10, the access request instruction to the tournament session opened for the first game, the confirmation unit 115 conducts certification for the first member, and then confirms a first required number which is the number of required tickets for participating in the tournament of the first game by referring to the game information storage unit 111, and confirms the quantity of holding tickets held by the first member by referring to the ticket information storage unit 112.

When it is confirmed that the quantity of holding tickets held by the first member is equal to or more than the first required number, the reduction processing unit 116 allows the first electronic terminal 10 to access the tournament session, and then reduces the quantity of holding tickets for the first member stored in the ticket information storage unit 112 by the first required number.

In this regard, when it is assumed that the information is stored in the game information storage unit 111 as in Table 1 above and the information is stored in the ticket information storage unit 112 as in Table 2 above, and the first game is referred to as ‘game 2 and the first member is referred to as ‘member 4’, since ‘5’ which is the quantity of holding tickets held by ‘member 4’ is equal to or more than ‘1’ which is the first required number to participate in the tournament for ‘game 2’, the reduction processing unit 116 may allow the first electronic terminal 10 to access the tournament session for ‘game 2’, and then reduce the quantity of holding tickets held by ‘member 4’ stored in the ticket information storage unit 112 by ‘1’, and change the quantity of holding tickets to ‘4’.

As such, after the access of the first electronic terminal 10 to the tournament session is allowed, when there is a situation in which the first member is matched with a second member who accesses the tournament session to perform a battle for the first game, the opening unit 117 opens a betting session for betting on a member who is predicted to win the game between the first member and the second member.

In this regard, when it is assumed that the first member is ‘member 4 and the second member is ‘member 2’, the first game is ‘game 2’, and there is a situation in which the access of the first electronic terminal 10 to the tournament session for ‘game 2’ is allowed, and then ‘member 4’ is matched with ‘member 2’ who accesses the tournament session for ‘game 2’ and perform the battle for ‘game 2’, by the reduction processing unit 116, the opening unit 117 may open a betting session for enabling betting on a member who is predicted to win between ‘member 4’ and ‘member 2’.

When a providing request instruction for requesting providing match prediction information in a battle for the first game is received from electronic terminals of a plurality of betting participation members who access the betting session among the plurality of members after the betting session is opened, the information transmission unit 118 confirms record information of each of the first member and the second member for the first game by referring to the record information storage unit 114, and then compute a winning rate of each of the first member and the second member for the first game, and generates the match prediction information based on the winning rate of each of the first member and the second member for the first game, and transmits the generated match prediction information to the electronic terminals of the plurality of betting participation members.

In this case, according to an exemplary embodiment of the present disclosure, the information transmission unit 118 may include a correction value storage unit 121, a wining rate computation unit 122, a correction unit 123, and a transmission processing unit 124.

The correction value storage unit 121 stores a plurality of predetermined range values for the number of game battles, and pre-designated winning rate correction values corresponding to the plurality of range values, respectively.

For example, the correction value storage unit 121 may store information shown in Table 5 below.

TABLE 5

| Plurality of range values | Winning rate correction value |
|---|---|
| 100 times or more | 1 |
| 75 times or more and less than 100 times | 0.9 |
| 50 times or more and less than 75 times | 0.8 |
| 25 times or more and less than 50 times | 0.6 |
| less than 25 times | 0.4 |

When the providing request instruction for requesting providing the match prediction information is received from the electronic terminals of the plurality of betting participation members after the betting session is opened, the winning rate computation unit 122 confirms the record information of each of the first member and the second member for the first game by referring to the record information storage unit 114, and then computes the wining rate of each of the first member and the second member for the first game.

When the winning rate of each of the first member and the second member for the first game is computed, the correction unit 123 confirms a first winning rate correction value corresponding to range value to which a first game battle number which is a total number of times at which the first member performs the battle for the first game belongs, among the plurality of range values, by referring to the correction value storage unit 121, and then multiplies the winning rate of the first member for the first game by the first winning rate correction value to correct the winning rate of the first member for the first game, and confirms a second winning rate correction value corresponding to a range value to which a second game battle number which is a total number of times at which the second member performs the battle for the first game belongs among the plurality of range values, and then multiplies the winning rate of the second member for the first game by the second winning rate correction value to correct the wining rate of the second member for the first game.

When the correction of the winning rate of each of the first member and the second member for the first game is completed, the transmission processing unit 124 generates the match prediction information constituted by prediction information indicating that a member having a higher corrected winning rate between the first member and the second member is a member who is predicted to win, and corrected winning rate information of each of the first member and the second member for the first game, and transmits the generated match prediction information to the electronic terminals of the plurality of betting participation members.

Hereinafter, the operations of the wining rate computation unit 122, the correction unit 123, and the transmission processing unit 124 will be described in detail as an example.

First, as in the above-described example, it is assumed that the record information storage unit 114 stores the information shown in Table 4 above, the correction value storage unit 121 stores the information shown in Table 5 above, and the first member is ‘member 4’, the second member is ‘member 2’, and the first game is ‘game 2’.

Further, it is assumed that after the opening unit 117 opens a betting session for enabling betting on a member who is predicted to win between ‘member 4’ and ‘member 2’, ‘member 5, member 6, member 7, member 8, and member 9’ among the plurality of members access the betting session for participating in betting.

In this case, when it is assumed that the service providing server 110 receives the providing request instruction for requesting providing the match prediction information from the electronic terminals of ‘member 5, member 6, member 7, member 8, and member 9’ which are the plurality of betting participation members, the winning rate computation unit 122 may confirm record information of ‘member 4’ and ‘member 2’ for ‘game 2’, respectively as ‘72 wins 18 losses and 30 wins 20 losses’, by referring to the record information storage unit 114, and then compute winning rates of ‘member 4’ and ‘member 2’ for ‘game 2’,respectively as ‘0.8 and 0.6’.

Then, the correction unit 123 may correct the winning rate of each of ‘member 4’ and ‘member 2’ for ‘game 2’ based on the total number of times at which each of ‘member 4’ and ‘member 2’ performs the battle for ‘game 2’.

In this regard, since the first game battle number which is the total number of times at which ‘member 4’ performs the battle for ‘game 2’ is ‘90 times’ confirms the first winning rate correction value corresponding to ‘75 times or more and less than 100 times’ which is the range value to which the first game battle number belongs among the plurality of range values as ‘0.9’ by referring to the correction value storage unit 121, and then multiplies ‘0.8’ which is the winning rate of ‘member 4’ for ‘game 2’ by the first winning rate correction value to correct the winning rate of ‘member 4’ for ‘game 2’ as ‘0.72’, and by such a scheme, the correction unit 123 may also correct the winning rate of ‘member 2’ for ‘game 2’ as ‘0.48’.

Then, the transmission processing unit 124 may generate the match prediction information constituted by the prediction information indicating that ‘member 4’ having the higher correct winning rate between ‘member 4’ and ‘member 2’ is the member who is predicted to win in the battle for ‘game 2’, and the corrected winning rate information of each of ‘member 4’ and ‘member 2’ for ‘game 2, and transmit the generated match prediction information to the electronic terminals of ‘member 5, member 6, member 7, member 8, and member 9’.

When the match prediction information is transmitted to the electronic terminals of the plurality of betting participation members, and then a betting request instruction for any one member of the first member and the second member is received from the electronic terminals of the plurality of betting participation members, the table generation unit 119 generates a betting table in which selection information for a member which each of the plurality of betting participation members selects as a betting target is recorded.

In this regard, as in the above-described example, it is assumed that the first member is ‘member 4’, the second member is ‘member 2’, the plurality of betting participation members are ‘member 5, member 6, member 7, member 8, and member 9’, and the information transmission unit 118 transmits the match prediction information to the electronic terminals of the plurality of betting participation members.

When it is assumed that the service providing server 110 receives a betting request instruction for any one member of ‘member 4’ and ‘member 2’ from the electronic terminals of ‘member 5, member 6, member 7, member 8, and member 9’, the table generation unit 119 may generate a betting table in which selection information for a member which each of ‘member 5, member 6, member 7, member 8, and member 9’ selects as the betting target is recorded as in Table 6 below.

TABLE 6

| Plurality of betting participation | |
|---|---|
| members | Member selected as betting target |
| Member 5 | Member 4 |
| Member 6 | Member 2 |
| Member 7 | Member 2 |
| Member 8 | Member 4 |
| Member 9 | Member 4 |

After the betting table is generated, when it is determined that the first member wins as a result of performing the battle for the first game, the reward processing unit 120 confirms first betting members who bets on the first member among the plurality of betting participation members by referring to the betting table, and then confirms a wallet address of each of the first betting members by referring to the wallet address storage unit 113, and transfers cryptocurrency corresponding to a predetermined dividend payment amount to the wallet address of each of the first betting members to complete reward processing for the first betting members, and when it is determined that the second member wins, confirms second betting members who bets on the second member among the plurality of betting participation members by referring to the betting table, and then confirms a wallet address of each of second betting members who bet on the second member among the plurality of betting participation members by referring to the wallet address storage unit 113, and then transfers cryptocurrency of the dividend payment amount to the wallet address of each of the second betting members to complete reward processing for the second betting members.

In this regard, as in the above-described example, it is assumed that the wallet address storage unit 113 stores the information shown in Table 3 above, the first member is ‘member 4’, the second member is ‘member 2’, and the first game is ‘game 2’, and the table generation unit 119 generates the betting table as in Table 6 above.

In this case, when it is determined that ‘member 4’ wins according to a result of performing the battle for ‘game 2’ in which ‘member 4’ is matched with ‘member 2’, the reward processing unit 120 may confirm the first betting members who bet on ‘member 4’ among the plurality of betting participation members as ‘member 5, member 8, and member 9’ who bet on ‘member 4’ among the plurality of betting participation members by referring to the betting table, and then confirm wallet addresses of ‘member 5, member 8, and member 9’, respectively as ‘address 5’, ‘address 8’, and ‘address 9’ by referring to the wallet address storage unit 113.

In this case, when the cryptocurrency corresponding to the predetermined dividend payment amount is ‘1 coin’, the reward processing unit 120 transfers the cryptocurrency corresponding to ‘1 coin’ to ‘address 5, address 8, and address 9’ to complete the reward processing for ‘member 5, member 8, and member 9’ who succeed in betting in the battle for ‘game 2’.

According to an exemplary embodiment of the present disclosure, the service providing server 110 may further include a transaction generation unit 125 and a registration request unit 126.

When the transfer processing of the cryptocurrency corresponding to the dividend payment amount for the first game is completed by the reward processing unit 120, the transaction generation unit 125 generates a transaction including winning and losing result information for the first game, information on the betting members who receive the dividend payment amount, and information on the dividend payment amount received by each betting member.

When the transaction is generated, the registration request unit 126 randomly selects a first node device which is any one of a plurality of node devices 101, 102, 103, 104, 105, and 106 constituting the blockchain network 100, and transmits a registration request of the transaction in the blockchain network 100 while transmitting the transaction to the first node device.

In this regard, as in the above-described example, it is assumed that the first game is ‘game 2’, and it is determined that ‘member 4’ wins the battle for ‘game 2’, and as a result, the transfer processing of the cryptocurrency of ‘1 coin’ as the dividend payment amount is completed with respect to ‘member 5’, ‘member 8’, and ‘member 9’ who bet on ‘member 4’ by the reward processing unit 120.

Then, the transaction generation unit 125 may generate a transaction including winning and losing result information for ‘game 2’, information on ‘member 5’, ‘member 8’, and ‘member 9’ who receive the dividend payment amount, and information on the cryptocurrency of ‘1 coin’ received by each betting member.

Then, the registration request unit 126 may randomly select the node device 101 which is any one of the plurality of node devices 101, 102, 103, 104, 105, and 106 constituting the blockchain network 100, and transmit the registration request of the transaction in the blockchain network 100 while transmitting the transaction to the node device 101.

In this case, when the first node device receives the transaction and the registration request from the service providing server 110, the first node device generates a first block including the transaction based on a previous block connected to blockchain data stored in a memory of the first node device by a chain, and connects the first block to the blockchain data by the chain to complete storing of the first block, and then propagates the first block to the remaining node devices other than the first node device among the plurality of node devices 101, 102, 103, 104, 105, and 106 through the blockchain network 100.

For example, as in the above-described example, as the registration request unit 126 transmits the registration request of the transaction in the blockchain network 100 while transmitting the transaction to the node device 101, when the node device 101 receives the transaction and the registration request from the service providing server 110, the node device 101 may generate the first block including the transaction based on the previous block connected to the blockchain data stored in the memory of the node device 101 by the chain.

Then, the node device 101 connects the first block to the blockchain data by the chain to complete storing the first block, and then propagate the first block to the remaining node devices 102, 103, 104, 105, and 106 through the blockchain network 100. Then, the remaining node devices 102, 103, 104, 105, and 106 connect the first block to the blockchain data by the chain based on the previous block connected to the blockchain data stored in each node device by the chain to share the transaction.

According to an exemplary embodiment of the present disclosure, upon receiving the access request instruction to the tournament session opened for the first game from the first electronic terminal 10 of the first member, the service providing server 110 conducts the certification for the first member, and then only when it is confirmed that the first member is a certified member, the service providing server 110 may further include a configuration of conducting a process for determining whether to allow the first electronic terminal 10 to access the tournament session based on the ticket held by the first member.

To this end, the confirmation unit 115 may include an e-mail storage unit 127, a public key storage unit 128, a certification event generation unit 129, a certification information generation unit 130, a norm operating unit 131, a certification request unit 132, and a certification processing unit 133.

The e-mail storage unit 127 stores information on a predetermined e-mail address for each of the plurality of members.

For example, the e-mail storage unit 127 may store information shown in Table 7 below.

TABLE 7

| Plurality of members | E-mail address |
|---|---|
| Member 1 | E-mail address 1 |
| Member 2 | E-mail address 2 |
| Member 3 | E-mail address 3 |
| Member 4 | E-mail address 4 |
| . . . | . . . |

The public key storage unit 128 stores a public key corresponding to a private key (the private key for each of the plurality of members is stored in the electronic terminal of each member) pre-issued for each of the plurality of members.

For example, the public key storage unit 128 may store information as in Table 8 below.

TABLE 8

| Plurality of members | Public key |
|---|---|
| Member 1 | Public key 1 |
| Member 2 | Public key 2 |
| Member 3 | Public key 3 |
| Member 4 | Public key 4 |
| . . . | . . . |

The certification event generation unit 129 generates a certification event for conducting the certification for the first member when receiving the access request instruction to the tournament session from the first electronic terminal 10.

The certification information generation unit 130 randomly generates, when the certification event is generated, an n (n is a natural number of 2 or more)-digit first certification number, randomly generates a certification value constituted by a natural number having a size of 9 or less, and then, performs a modulo operation having the certification value as a divisor for respective digit numbers constituting the first certification number to generate an n-digit second certification number.

For example, when n is ‘3’, the certification information generation unit 130 randomly generates a 3-digit first certification number as ‘642’, randomly generates a certification value configured by a natural number having a size of 9 or less as ‘5’, and then performs a modulo operation having ‘5’ which is the certification value as the divisor for ‘6’, ‘4’, and ‘2’ which are respective digit numbers constituting the first certification number to generate a 3-digit second certification number as ‘142’.

When the first certification number and the second certification number are generated, the norm operating unit 131 generates a column vector having respective digit numbers constituting the first certification number as components and a row vector having respective digit numbers constituting the second certification number as components, and operates a matrix multiplication between the column vector and the row vector to generate an operation matrix of an n x n size, and then operates Frobenius Norm of the operation matrix.

Here, Frobenius Norm means L2-Norm that represents the size of the matrix.

In this regard, as in the above-described example, when the first certification number is generated as ‘642’ and the second certification number is generated as ‘142’ through the certification information generation unit 130, the Norm operating unit 131 generates a column vector having respective digit numbers constituting ‘642’ which is the first certification number as components as

$$‘ [ \begin{matrix}6 \\ 4 \\ 2\end{matrix} ] ’ ,$$

generates a row vector having respective digit numbers constituting ‘142’ which is the second certification number as components as ‘[1 4 2]’, and then operates the matrix multiplication between the column vector and the row vector to generate an operation matrix having a size of 3×3 as

$$‘ [ \begin{matrix}6 & 24 & 12 \\ 4 & 16 & 8 \\ 2 & 8 & 4\end{matrix} ] ’ ,$$

and operate Frobenius Norm of the operation matrix.

When the Frobenius Norm of the operation matrix is computed, the certification request unit 132 confirms a first e-mail address for the first member by referring to the e-mail storage unit 127, sends a certification e-mail including the first certification number with the first e-mail address as a receiving side, and then transmits the certification value to the first electronic terminal 10, and at the same time, requests an electronic signature based on the first certification number and the certification value.

For example, as in the above-described example, when the first certification number and the certification value are ‘642’ and ‘5’, respectively, and the first member is ‘member 4’, the certification request unit 132 may refer to the e-mail storage unit 127 shown in Table 7 above, confirm ‘e-mail address 4’ for ‘member 4’, and send the certification e-mail including ‘642’ which is the first certification number with ‘e-mail address 4’ as the receiving side. Then, the certification request unit 132 may transmit ‘5’ which is the certification value to the first electronic terminal 10, and at the same time, request the electronic signature based on the first certification number and the certification value.

In this case, according to an exemplary embodiment of the present disclosure, upon receiving the electronic signature request from the service providing server 110 jointly with the certification value, the first electronic terminal 10 may display a message for requesting the first member to input the first certification number included in the certification e-mail received by an account according to the first e-mail address into the first electronic terminal 10.

In this case, when the first member inputs, into the first electronic terminal 10, the first certification number included in the certification e-mail received by the account according to the first e-mail address in response to the message, the first electronic terminal 10 performs the modulo operation having the certification value as the divisor for the respective digit numbers constituting the first certification number to generate the second certification number, and then generate a column vector having respective digit numbers constituting the first certification number as components and a row vector having respective digit numbers constituting the second certification number as components, and operates the matrix multiplication between the column vector and the row vector to generate the operation matrix, and then sign the Frobenius Norm of the operation matrix with the first private key for the first member stored in the first electronic terminal 10 to generate a first electronic signature value, and transmit the generated first electronic signature value to the service providing server 110 of the present disclosure.

In this regard, as in the above-described example, when the first certification number and the certification value are ‘642’ and ‘5’, respectively, and the first member is ‘member 4’, the first electronic terminal 10 may display a message for requesting ‘member 4’ to input the first certification number included in the certification e-mail received by the account according to ‘e-mail address 4’ into the first electronic terminal 10 when receiving the electronic signature request from the service providing server 110 jointly with ‘5’ which is the certification value.

Then, ‘member 4’ logs into the account according to ‘e-mail address 4’ to confirm the certification e-mail, and confirms ‘642’ which is the first certification number included in the certification e-mail to input the ‘642’ into the first electronic terminal 10. As such, when ‘member 4’ inputs ‘642’ which is the first certification number included in the certification e-mail into the first electronic terminal 10, the first electronic terminal 10 performs a modulo operation having ‘5’ which is the certification value as the divisor for ‘6’, ‘4’, and ‘2’ which are respective digit numbers constituting the first certification number to generate the second certification number as ‘142’.

Then, the first electronic terminal 10 generates a column vector having respective digit numbers constituting ‘642’ which is the first certification number as components as

$$‘ [ \begin{matrix}6 \\ 4 \\ 2\end{matrix} ] ’$$

and generates a row vector having respective digit numbers constituting ‘142’ which is the second certification number as components as ‘[1 4 2]’, and then operates the matrix multiplication between the column vector and the row vector to generate the operation matrix as

$$‘ [ \begin{matrix}6 & 24 & 12 \\ 4 & 16 & 8 \\ 2 & 8 & 4\end{matrix} ] ’ .$$

Then, the first electronic terminal 10 operates the Frobenius Norm of the operation matrix, and then performs the electronic signature for the Frobenius Norm based on ‘private key 4’ which is the private key for ‘member 4’ pre-stored in the first electronic terminal 10 to generate the first electronic signature value and transmit the first electronic signature value to the service providing server 110 of the present disclosure.

Upon receiving the first electronic signature value in response to the electronic signature request from the first electronic terminal 10, the certification processing unit 133 extracts a first public key for the first member from the public key storage unit 128, and then compares a value acquired by decoding the first electronic signature value based on the first public key and the Frobenius Norm of the operation matrix with each other, and when it is confirmed that both values coincide with each other, completes the certification for the first member.

In this regard, as in the above-described example, when the first member is ‘member 4’, the certification processing unit 133 may extract ‘public key 4’ which is a public key for ‘member 4’ from the public key storage unit 128 as in Table 8 above, and then decode the first electronic signature value based on ‘public key 4’, upon receiving the first electronic signature value from the first electronic terminal 10.

Thereafter, the certification processing unit 133 may compare a decoding value for the first electronic signature value and the Frobenius Norm of the operation matrix with each other, and when it is confirmed that both values coincide with each other, complete the certification for ‘member 4’.

According to an exemplary embodiment of the present disclosure, the service providing server 110 may further include a price information storage unit 134, a payment processing unit 135, and an increment processing unit 136.

The price information storage unit 134 stores purchase price information of the ticket for participating in the tournament.

For example, the price information storage unit 134 may store purchase price information of ‘5000 won per ticket’ as the purchase price information of the ticket.

Upon receiving the purchase request instruction of requesting purchasing tickets as many as a first purchase quantity from the first electronic terminal 10, the payment processing unit 135 requests transmission of payment means information to the first electronic terminal 10, and upon receiving first payment means information from the first electronic terminal 10, the payment processing unit 135 calculates a price corresponding to the first purchase quantity based on the purchase price information stored in the price information storage unit 134, and then perform cost payment processing for the calculated price based on the first payment means information.

In this regard, as in the above-described example, it is assumed that the price information storage unit 134 stores the purchase price information of the ticket as ‘5000 won per ticket’.

In this case, when the service providing server 110 receives a purchase request instruction for requesting purchasing ‘5’ tickets from the first electronic terminal 10, the payment processing unit 135 may request transmission of payment means information to the first electronic terminal 10, and when the service providing server 110 receives credit card information from the first electronic terminal 10 in response thereto, the payment processing unit 135 may calculate a price corresponding to a purchase quantity of ‘5’ tickets as ‘25000 won’ based on the purchase price information, and then perform cost payment processing for ‘25000 won’ based on the credit card information.

When the cost payment processing is completed, the increment processing unit 136 increases the quantity of holding tickets for the first member stored in the ticket information storage unit 112 by the first purchase quantity.

In this regard, as in the above-described example, when the ticket information storage unit 112 stores the information shown in Table 2 above, the first member is ‘member 4’, and the payment processing unit 135 completes the cost payment processing for ‘25000 won’, the increment processing unit 136 may increase the quantity of holding tickets for ‘member 4’ stored in the ticket information storage unit 112 by ‘5, and change the quantity of holding tickets to ‘10’.

According to an exemplary embodiment of the present disclosure, the service providing server 110 may further include a reward information storage unit 137, a reward confirmation unit 138, and a winning reward processing unit 139.

The reward information storage unit 137 stores information on the amount of payment of cryptocurrency to be paid as a reward when winning the tournament for each of the plurality of games.

For example, the reward information storage unit 137 may store information as in Table 9 below.

TABLE 9

| | Cryptocurrency payment amount when | |
|---|---|---|
| Plurality of games | winning | |
| Game 1 | 5 | coins |
| Game 2 | 2 | coins |
| Game 3 | 13 | coins |
| Game 4 | 20 | coins |

| | |
|---|---|
| . . . | . . . |

When an event occurs, which indicates that the first member is a winner through the tournament session as the first members wins the tournament for the first game after the first member completes participating in the tournament for the first game as the first electronic terminal 10 accesses the tournament session, the reward confirmation unit 138 confirms a first payment amount which is the payment amount of the cryptocurrency to be paid as the reward when winning the tournament for the first game by referring to the reward information storage unit 137, and confirms the wallet address of the first member by referring to the wallet address storage unit 113.

The winning reward processing unit 139 transfers the cryptocurrency of the first payment amount to the wallet address of the first member to complete reward processing for the first member.

In this regard, as in the above-described example, it is assumed that the information shown in Table 3 above is stored in the wallet address storage unit 113. Further, a situation is assumed in which the first member is ‘member 4’, the first game is ‘game 2’, and as the first electronic terminal 10 accesses the tournament session opened for ‘game 2’, ‘member 4’ completes participating in the tournament for ‘game 2’.

When ‘member 4’ wins the tournament for ‘game 2’, the service providing server 110 may generate an event indicating that ‘member 4’ is the winner through the tournament session opened for ‘game 2’. As such, when the event indicating that ‘member 4’ is the winner is generated through the tournament session opened for ‘game 2’, the reward confirmation unit 138 may confirm that the payment amount of the cryptocurrency to be paid as the reward when winning the tournament for ‘game 2’ is ‘2 coins’ by referring to the reward information storage unit 137, and confirm the wallet address of ‘member 4’ as ‘address 4’ by referring to the wallet address storage unit 113.

Then, the winning reward processing unit 139 transfers the cryptocurrency as much as ‘2 coins’ to ‘address 4’ which is the wallet address of ‘member 4’ to complete reward processing for ‘member 4’.

Through this, when the members win the tournaments for the games participated thereby, the members may receive the rewards thereof as cryptocurrency, and will be able to more actively participate in the tournaments for the games due to the reward.

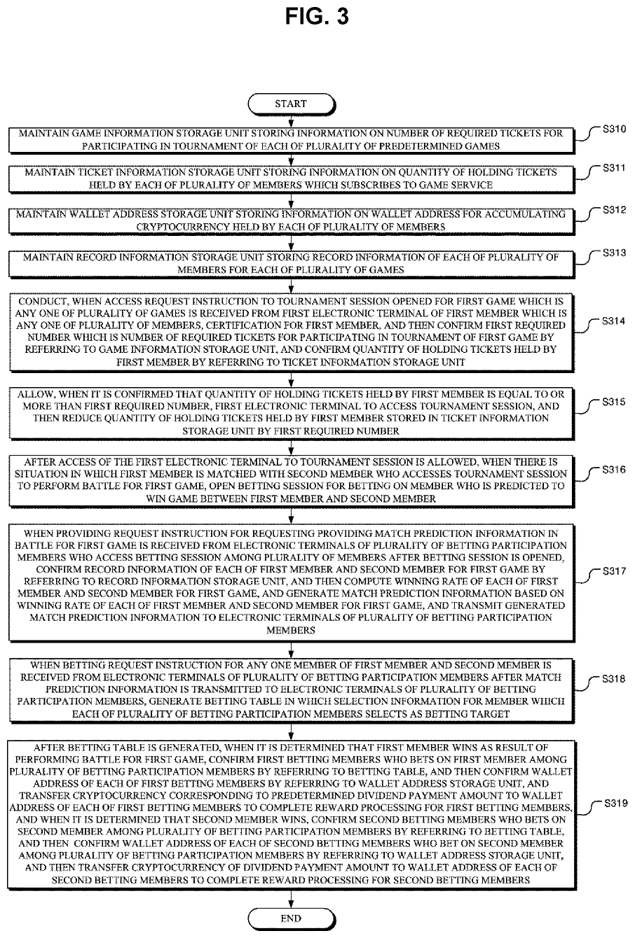

FIG. 3 is a flowchart illustrating an operating method of a service providing server for providing a game service that supports participation in a tournament for a game using a ticket and enables match prediction and betting on members participating in the tournament according to an exemplary embodiment of the present disclosure.

In step S310, a game information storage unit is maintained, which stores information on the number of required tickets for participating in tournaments of a plurality of predetermined respective games.

In step S311, a ticket information storage unit is maintained, which stores information on the quantity of holding tickets held by each of a plurality of members which subscribes to the game service.

In step S312, a wallet address storage unit is maintained, which stores information on a wallet address for accumulating cryptocurrency held by each of the plurality of members.

In step S313, a record information storage unit is maintained, which stores record information of each of the plurality of members for each of the plurality of games (the record information for each of the plurality of games is information in which victory/defeat records in the match for each of the plurality of games of each member are divided and recorded for each game).

In step S314, when an access request instruction to a tournament session (the tournament session means a session opened for allowing members accessing the tournament session through the electronic terminal to play the first game online jointly) opened for a first game which is any one of the plurality of games is received from a first electronic terminal of a first member which is any one of the plurality of members, certification for the first member is conducted, and then a first required number which is the number of required tickets for participating in the tournament of the first game is confirmed by referring to the game information storage unit, and the quantity of holding tickets held by the first member is confirmed by referring to the ticket information storage unit.

In step S315, when it is confirmed that the quantity of holding tickets held by the first member is equal to or more than the first required number, the first electronic terminal is allowed to access the tournament session, and then the quantity of holding tickets for the first member stored in the ticket information storage unit is reduced by the first required number.

In step S316, after the access of the first electronic terminal to the tournament session is allowed, when there is a situation in which the first member is matched with a second member who accesses the tournament session to perform a battle for the first game, a betting session for betting on a member who is predicted to win the game between the first member and the second member is opened.

In step S317, when a providing request instruction for requesting providing match prediction information in a battle for the first game is received from electronic terminals of a plurality of betting participation members who access the betting session among the plurality of members after the betting session is opened, record information of each of the first member and the second member for the first game is confirmed by referring to the record information storage unit, and then a winning rate of each of the first member and the second member for the first game is computed, and the match prediction information is generated based on the winning rate of each of the first member and the second member for the first game, and the generated match prediction information is transmitted to the electronic terminals of the plurality of betting participation members.

In step S318, when the match prediction information is transmitted to the electronic terminals of the plurality of betting participation members, and then a betting request instruction for any one member of the first member and the second member is received from the electronic terminals of the plurality of betting participation members, a betting table is generated in which selection information for a member which each of the plurality of betting participation members selects as a betting target is recorded.

In step S319, after the betting table is generated, when it is determined that the first member wins as a result of performing the battle for the first game, first betting members who bets on the first member are confirmed among the plurality of betting participation members by referring to the betting table, and then a wallet address of each of the first betting members is confirmed by referring to the wallet address storage unit, and cryptocurrency corresponding to a predetermined dividend payment amount is transferred to the wallet address of each of the first betting members to complete reward processing for the first betting members, and when it is determined that the second member wins, second betting members who bets on the second member among the plurality of betting participation members are confirmed by referring to the betting table, and then a wallet address of each of second betting members who bet on the second member among the plurality of betting participation members is confirmed by referring to the wallet address storage unit, and then cryptocurrency of the dividend payment amount is transferred to the wallet address of each of the second betting members to complete reward processing for the second betting members.

In this case, according to an exemplary embodiment of the present disclosure, step S317 may include a step of maintaining a correction value storage unit storing a plurality of predetermined range values for the number of game battles, and pre-designated winning rate correction values corresponding to the plurality of range values, respectively, a step of confirming, when the providing request instruction for requesting providing the match prediction information is received from the electronic terminals of the plurality of betting participation members after the betting session is opened, the record information of each of the first member and the second member for the first game by referring to the record information storage unit, and then computing the wining rate of each of the first member and the second member for the first game, a step of confirming, when the winning rate of each of the first member and the second member for the first game is computed, a first winning rate correction value corresponding to a range value to which a first game battle number which is a total number of times at which the first member performs the battle for the first game belongs, among the plurality of range values, by referring to the correction value storage unit, and then multiplying the winning rate of the first member for the first game by the first winning rate correction value to correct the winning rate of the first member for the first game, and confirming a second winning rate correction value corresponding to a range value to which a second game battle number which is a total number of times at which the second member performs the battle for the first game belongs among the plurality of range values, and then multiplying the winning rate of the second member for the first game by the second winning rate correction value to correct the wining rate of the second member for the first game, and a step of generating, when the correction of the winning rate of each of the first member and the second member for the first game is completed, the match prediction information constituted by prediction information indicating that a member having a higher corrected winning rate between the first member and the second member is a member who is predicted to win, and corrected winning rate information of each of the first member and the second member for the first game, and transmitting the generated match prediction information to the electronic terminals of the plurality of betting participation members. Further, according to an exemplary embodiment of the present disclosure, the operating method of the service providing server may further include, when the transfer of the cryptocurrency of the dividend payment amount for the first game is completed by step S319, generating a transaction including winning and losing result information for the first game, information on betting members receiving the dividend payment amount, and information on the dividend payment amount received by each betting member, and when the transaction is generated, randomly selecting a first node device which is any one of a plurality of node devices constituting a blockchain network, and transmitting a registration request of the transaction in the blockchain network while transmitting the transaction to the first node device.

In this case, when the first node device receives the transaction and the registration request from the service providing server, the first node device generates a first block including the transaction based on a previous block connected to blockchain data stored in a memory of the first node device by a chain, and connects the first block to the blockchain data by the chain to complete storing of the first block, and then propagates the first block to the remaining node devices other than the first node device among the plurality of node devices through the blockchain network.

Further, according to an exemplary embodiment of the present disclosure, step S314 may include a step of maintaining an e-mail storage unit storing information on a predetermined e-mail address for each of the plurality of members, a step of maintaining a public key storage unit storing a public key corresponding to a private key (the private key for each of the plurality of members is stored in the electronic terminal of each member) pre-issued for each of the plurality of members, a step of generating a certification event for conducting the certification for the first member when receiving the access request instruction to the tournament session from the first electronic terminal, a step of randomly generating, when the certification event is generated, an n (n is a natural number of 2 or more)-digit first certification number and randomly generating a certification value constituted by a natural number having a size of 9 or less, and then performing a module operation having the certification value as a divisor for respective digit number constituting the first certification number to generate an n-digit second certification number, a step of generating, when the first certification number and the second certification number are generated, a column vector having respective digit numbers constituting the first certification number as components and a row vector having respective digit numbers constituting the second certification number as components, and computing a matrix multiplication between the column vector and the row vector to generate an operation matrix of an n x n size, and then computing Frobenius Norm of the operation matrix, a step of confirming, when the Frobenius Norm of the operation matrix is computed, a first e-mail address for the first member by referring to the e-mail storage unit, sending a certification e-mail including the first certification number with the first e-mail address as a receiving side, and then transmitting the certification value to the first electronic terminal, and at the same time, requesting an electronic signature based on the first certification number and the certification value, and a step of extracting, upon receiving the first electronic signature value (the first electronic signature value is generated as when the certification value is received by the first electronic terminal, and the first member inputs, into the first electronic terminal, the first certification number included in the certification e-mail received by the account according to the first e-mail address, the first electronic terminal performs a modulo operation having the certification value as a divisor for each-digit number constituting the first certification number to generate an n-digit second certification number, and then generates a column vector having respective digit numbers constituting the first certification number as components and a row vector having respective digit numbers constituting the second certification number as components, and computing the matrix multiplication between the column vector and the row vector to generate the operation matrix, and then signing the Frobenius Norm of the operation matrix with the first private key for the first member stored in the first electronic terminal) in response to the electronic signature request from the first electronic terminal, a first public key for the first member from the public key storage unit, and then comparing a value acquired by decoding the first electronic signature value based on the first public key and the Frobenius Norm of the operation matrix with each other, and when it is confirmed that both values coincide with each other, completing the certification for the first member.

Further, according to an exemplary embodiment of the present disclosure, the operating method of the service providing server may further include a step of maintaining a price information storage unit storing purchase price information of the ticket for participating in the tournament, a step of requesting, upon receiving the purchase request instruction of requesting purchasing tickets as many as a first purchase quantity from the first electronic terminal, transmission of payment means information to the first electronic terminal, and upon receiving first payment means information from the first electronic terminal, calculating a price corresponding to the first purchase quantity based on the purchase price information stored in the price information storage unit, and then performing cost payment processing for the calculated price based on the first payment means information, and a step of increasing, when the cost payment processing is completed, the quantity of holding tickets for the first member stored in the ticket information storage unit by the first purchase quantity.

Further, according to an exemplary embodiment of the present disclosure, the operating method of the service providing server may further include a step of maintaining a reward information storage unit storing information on the amount of payment of cryptocurrency to be paid as a reward when winning the tournament for each of the plurality of games, a step of confirming, when an event occurs, which indicates that the first member is a winner through the tournament session as the first member wins the tournament for the first game after the first member completes participation in the tournament for the first game as the first electronic terminal accesses the tournament session, a first payment amount which is the payment amount of the cryptocurrency to be paid as the reward when winning the tournament for the first game by referring to the reward information storage unit, and confirming a wallet address of the first member by referring to the wallet address storage unit, and a step of completing reward processing for the first member by transferring cryptocurrency of the first payment amount to the wallet address of the first member.

Hereinabove, referring to FIG. 3, the operating method of the service providing server according to an exemplary embodiment of the present disclosure is described. Here, since the operating method of the service providing server according to an exemplary embodiment of the present disclosure may correspond to the configuration of the operation of the service providing server 110 described by using FIGS. 1 and 2, a more detailed description thereof will be omitted.

The operating method of the service providing server according to an exemplary embodiment of the present disclosure may be implemented by a computer program stored in a storage medium for executing the computer program through coupling with a computer.

Further, the operating method of the service providing server according to an exemplary embodiment of the present disclosure may be implemented in a program command type which may be performed through various computer means and recorded in a computer readable medium. The computer readable medium may include a program command, a data file, a data structure, etc., singly or combinationally. The program command recorded in the medium may be specially designed and configured for the present disclosure, or may be publicly known to and used by those skilled in the computer software field. An example of the computer readable recording medium includes magnetic media, such as a hard disk, a floppy disk, and a magnetic tape, optical media such as a CD-ROM and a DVD, magneto-optical media such as a floptical disk, and hardware devices such as a ROM, a RAM, and a flash memory, which are specially configured to store and execute the program command. An example of the program command includes a high-level language code executable by a computer by using an interpreter and the like, as well as a machine language code created by a compiler.

As described above, the present disclosure has been described by specified matters such as detailed components, and the like and limited exemplary embodiments and drawings, but the description is just provided to assist more overall understanding of the present disclosure and the present disclosure is not limited to the exemplary embodiment and various modifications and changes can be made by those skilled in the art from such a disclosure.

Accordingly, the spirit of the present disclosure should not be defined only by the described exemplary embodiments, and it should be appreciated that claims to be described below and all things which are equivalent to the claims or equivalently modified to the claims are included in the scope of the spirit of the present disclosure.

What is claimed is:

1. A service providing server for providing a game service that supports participation in a tournament for a game using a ticket and enables match prediction and betting on members participating in the tournament, comprising:
a game information storage unit storing information on the number of required tickets for participating in tournaments of a plurality of predetermined respective games;
a ticket information storage unit storing information on the quantity of holding tickets held by each of a plurality of members which subscribes to the game service;
a wallet address storage unit storing information on a wallet address for accumulating cryptocurrency held by each of the plurality of members;
a record information storage unit storing record information of each of the plurality of members for each of the plurality of games, wherein the record information for each of the plurality of games is information in which victory/defeat records in the match for each of the plurality of games of each member are divided and recorded for each game;
a confirmation unit conducting, when an access request instruction to a tournament session, wherein the tournament session means a session opened for allowing members accessing to the tournament session through the electronic terminal to play the first game online jointly, opened for a first game which is any one of the plurality of games is received from a first electronic terminal of a first member which is any one of the plurality of members, certification for the first member, and then confirming a first required number which is the number of required tickets for participating in the tournament of the first game by referring to the game information storage unit, and confirming the quantity of holding tickets held by the first member by referring to the ticket information storage unit;
a reduction processing unit allowing, when it is confirmed that the quantity of holding tickets held by the first member is equal to or more than the first required number, the first electronic terminal to access the tournament session, and then reducing the quantity of holding tickets for the first member stored in the ticket information storage unit by the first required number;
an opening unit opening, after the access of the first electronic terminal to the tournament session is allowed, when there is a situation in which the first member is matched with a second member who accesses the tournament session to perform a battle for the first game, a betting session for betting on a member who is predicted to win the game between the first member and the second member;
an information transmission unit confirming, when a providing request instruction for requesting providing match prediction information in a battle for the first game is received from electronic terminals of a plurality of betting participation members who access the betting session among the plurality of members after the betting session is opened, record information of each of the first member and the second member for the first game by referring to the record information storage unit, and then computing a winning rate of each of the first member and the second member for the first game, and generating the match prediction information based on the winning rate of each of the first member and the second member for the first game, and transmitting the generated match prediction information to the electronic terminals of the plurality of betting participation members;
a table generation unit generating, when the match prediction information is transmitted to the electronic terminals of the plurality of betting participation members, and then a betting request instruction for any one member of the first member and the second member is received from the electronic terminals of the plurality of betting participation members, a betting table in which selection information for a member which each of the plurality of betting participation members selects as a betting target is recorded; and
a reward processing unit confirming, after the betting table is generated, when it is determined that the first member wins as a result of performing the battle for the first game, first betting members who bets on the first member among the plurality of betting participation members by referring to the betting table, and then confirming a wallet address of each of the first betting members by referring to the wallet address storage unit, and transferring cryptocurrency corresponding to a predetermined dividend payment amount to the wallet address of each of the first betting members to complete reward processing for the first betting members, and confirming, when it is determined that the second member wins, second betting members who bets on the second member among the plurality of betting participation members by referring to the betting table, and then confirming a wallet address of each of the second betting members by referring to the wallet address storage unit, and then transferring cryptocurrency of the dividend payment amount to the wallet address of each of the second betting members to complete reward processing for the second betting members.

2. The service providing server of claim 1, wherein the information transmission unit includes
a correction value storage unit storing a plurality of predetermined range values for the number of game battles, and pre-designated winning rate correction values corresponding to the plurality of range values, respectively,
a winning rate computation unit confirming, when the providing request instruction for requesting providing the match prediction information is received from the electronic terminals of the plurality of betting participation members after the betting session is opened, the record information of each of the first member and the second member for the first game by referring to the record information storage unit, and then computing the wining rate of each of the first member and the second member for the first game,
a correction unit confirming, when the winning rate of each of the first member and the second member for the first game is computed, a first winning rate correction value corresponding to a range value to which a first game battle number which is a total number of times at which the first member performs the battle for the first game belongs, among the plurality of range values, by referring to the correction value storage unit, and then multiplying the winning rate of the first member for the first game by the first winning rate correction value to correct the winning rate of the first member for the first game, and confirming a second winning rate correction value corresponding to a range value to which a second game battle number which is a total number of times at which the second member performs the battle for the first game belongs among the plurality of range values, and then multiplying the winning rate of the second member for the first game by the second winning rate correction value to correct the wining rate of the second member for the first game, and
a transmission processing unit generating, when the correction of the winning rate of each of the first member and the second member for the first game is completed, the match prediction information constituted by prediction information indicating that a member having a higher corrected winning rate between the first member and the second member is a member who is predicted to win, and corrected winning rate information of each of the first member and the second member for the first game, and transmitting the generated match prediction information to the electronic terminals of the plurality of betting participation members.

3. The service providing server of claim 1, further comprising:
a transaction generation unit generating, when the transfer processing of the cryptocurrency of the dividend payment amount for the first game is completed by the reward processing unit, a transaction including winning and losing result information for the first game, information on betting members who receive the dividend payment amount, and information on the dividend payment amount received by each betting member; and
a registration request unit randomly selecting, when the transaction is generated, a first node device which is any one of a plurality of node devices constituting the blockchain network, and transmitting a registration request of the transaction in the blockchain network while transmitting the transaction to the first node device,
wherein when the first node device receives the transaction and the registration request from the service providing server, the first node device generates a first block including the transaction based on a previous block connected to blockchain data stored in a memory of the first node device by a chain, and connects the first block to the blockchain data by the chain to complete storing the first block, and then propagates the first block to the remaining node devices other than the first node device among the plurality of node devices through the blockchain network.

4. The service providing server of claim 1, wherein the confirmation unit includes
an e-mail storage unit storing information on a predetermined e-mail address for each of the plurality of members,
a public key storage unit storing a public key corresponding to a private key, wherein the private key for each of the plurality of members is stored in the electronic terminal of each member, pre-issued for each of the plurality of members,
a certification event generation unit generating a certification event for conducting the certification for the first member when receiving the access request instruction to the tournament session from the first electronic terminal,
a certification information generation unit randomly generating, when the certification event is generated, a n, wherein n is a natural number of 2 or more, digit first certification number, randomly generating a certification value constituted by a natural number having a size of 9 or less, and then, performing a modulo operation having the certification value as a divisor for respective digit numbers constituting the first certification number to generate an n-digit second certification number,
a Norm operating unit generating, when the first certification number and the second certification number are generated, a column vector having respective digit numbers constituting the first certification number as components and a row vector having respective digit numbers constituting the second certification number as components, and computing a matrix multiplication between the column vector and the row vector to generate an operation matrix of an n×n size, and then operates Frobenius Norm of the operation matrix, a certification request unit confirming, when the Frobenius Norm of the operation matrix is computed, a first e-mail address for the first member by referring to the e-mail storage unit, sending a certification e-mail including the first certification number with the first e-mail address as a receiving side, and then transmitting the certification value to the first electronic terminal, and at the same time, requesting an electronic signature based on the first certification number and the certification value, and
a certification processing unit extracting, when receiving a first electronic signature value, wherein the first electronic signature value is generated by performing, when the certification value is received in the first electronic terminal, and the first member inputs the first certification number included in the certification e-mail received by an account according to the first e-mail address into the first electronic terminal, by the first electronic terminal, the modulo operation having the certification value as the divisor for the respective digit numbers constituting the first certification number to generate the second certification number, and then generate a column vector having respective digit numbers constituting the first certification number as components and a row vector having respective digit numbers constituting the second certification number as components, and operating the matrix multiplication between the column vector and the row vector to generate the operation matrix, and then signing the Frobenius Norm of the operation matrix with the first private key for the first member stored in the first electronic terminal, from the first electronic terminal in response to the electronic signature request, the first public key for the first member from the public key storage unit, and then comparing a value acquired by decoding the first electronic signature value based on the first public key and the Frobenius Norm of the operation matrix with each other, and when it is confirmed that both values coincide with each other, completing the certification for the first member.

5. The service providing server of claim 1, further comprising:
a price information storage unit storing purchase price information of the ticket for participating in the tournament;
a payment processing unit requesting, upon receiving the purchase request instruction of requesting purchasing tickets as many as a first purchase quantity from the first electronic terminal, transmission of payment means information to the first electronic terminal, and upon receiving first payment means information from the first electronic terminal, calculating a price corresponding to the first purchase quantity based on the purchase price information stored in the price information storage unit, and then performing cost payment processing for the calculated price based on the first payment means information; and
an increment processing unit increasing, when the cost payment processing is completed, the quantity of holding tickets for the first member stored in the ticket information storage unit by the first purchase quantity.

6. An operating method of a service providing server for providing a game service that supports participation in a tournament for a game using a ticket and enables match prediction and betting on members participating in the tournament, comprising:
maintaining a game information storage unit storing information on the number of required tickets for participating in tournaments of a plurality of predetermined respective games;
maintaining a ticket information storage unit storing information on the quantity of holding tickets held by each of a plurality of members which subscribes in the game service;
maintaining a wallet address storage unit storing information on a wallet address for accumulating cryptocurrency held by each of the plurality of members;
maintaining a record information storage unit storing record information of each of the plurality of members for each of the plurality of games, wherein the record information for each of the plurality of games is information in which victory/defeat records in the match for each of the plurality of games of each member are divided and recorded for each game;
conducting, when an access request instruction to a tournament session, wherein the tournament session means a session opened for allowing members accessing to the tournament session through the electronic terminal to play the first game online jointly, opened for a first game which is any one of the plurality of games is received from a first electronic terminal of a first member which is any one of the plurality of members, certification for the first member, and then confirming a first required number which is the number of required tickets for participating in the tournament of the first game by referring to the game information storage unit, and confirming the quantity of holding tickets held by the first member by referring to the ticket information storage unit;
allowing, when it is confirmed that the quantity of holding tickets held by the first member is equal to or more than the first required number, the first electronic terminal to access the tournament session, and then reducing the quantity of holding tickets for the first member stored in the ticket information storage unit by the first required number;
opening, after the access of the first electronic terminal to the tournament session is allowed, when there is a situation in which the first member is matched with a second member who accesses the tournament session to perform a battle for the first game, a betting session for betting on a member who is predicted to win the game between the first member and the second member;
confirming, when a providing request instruction for requesting providing match prediction information in a battle for the first game is received from electronic terminals of a plurality of betting participation members who access the betting session among the plurality of members after the betting session is opened, record information of each of the first member and the second member for the first game by referring to the record information storage unit, and then computing a winning rate of each of the first member and the second member for the first game, and generating the match prediction information based on the winning rate of each of the first member and the second member for the first game, and transmitting the generated match prediction information to the electronic terminals of the plurality of betting participation members;
generating, when the match prediction information is transmitted to the electronic terminals of the plurality of betting participation members, and then a betting request instruction for any one member of the first member and the second member is received from the electronic terminals of the plurality of betting participation members, a betting table in which selection information for a member which each of the plurality of betting participation members selects as a betting target is recorded; and
confirming, after the betting table is generated, when it is determined that the first member wins as a result of performing the battle for the first game, first betting members who bets on the first member among the plurality of betting participation members by referring to the betting table, and then confirming a wallet address of each of the first betting members by referring to the wallet address storage unit, and transferring cryptocurrency corresponding to a predetermined dividend payment amount to the wallet address of each of the first betting members to complete reward processing for the first betting members, and confirming, when it is determined that the second member wins, second betting members who bets on the second member among the plurality of betting participation members by referring to the betting table, and then confirming a wallet address of each of the second betting members by referring to the wallet address storage unit, and then transferring cryptocurrency of the dividend payment amount to the wallet address of each of the second betting members to complete reward processing for the second betting members.

7. The operating method of claim 6, wherein the confirming record information includes
maintaining a correction value storage unit storing a plurality of predetermined range values for the number of game battles, and pre-designated winning rate correction values corresponding to the plurality of range values, respectively,
confirming, when the providing request instruction for requesting providing the match prediction information is received from the electronic terminals of the plurality of betting participation members after the betting session is opened, the record information of each of the first member and the second member for the first game by referring to the record information storage unit, and then computing the wining rate of each of the first member and the second member for the first game,
confirming, when the winning rate of each of the first member and the second member for the first game is computed, a first winning rate correction value corresponding to a range value to which a first game battle number which is a total number of times at which the first member performs the battle for the first game belongs, among the plurality of range values, by referring to the correction value storage unit, and then multiplying the winning rate of the first member for the first game by the first winning rate correction value to correct the winning rate of the first member for the first game, and confirming a second winning rate correction value corresponding to a range value to which a second game battle number which is a total number of times at which the second member performs the battle for the first game belongs among the plurality of range values, and then multiplying the winning rate of the second member for the first game by the second winning rate correction value to correct the wining rate of the second member for the first game, and
generating, when the correction of the winning rate of each of the first member and the second member for the first game is completed, the match prediction information constituted by prediction information indicating that a member having a higher corrected winning rate between the first member and the second member is a member who is predicted to win, and corrected winning rate information of each of the first member and the second member for the first game, and transmitting the generated match prediction information to the electronic terminals of the plurality of betting participation members.

8. The operating method of claim 6, further comprising:
generating, when the transfer processing of the cryptocurrency of the dividend payment amount for the first game is completed, a transaction including winning and losing result information for the first game, information on betting members who receive the dividend payment amount, and information on the dividend payment amount received by each betting member; and
randomly selecting, when the transaction is generated, a first node device which is any one of a plurality of node devices constituting the blockchain network, and transmitting a registration request of the transaction in the blockchain network while transmitting the transaction to the first node device,
wherein when the first node device receives the transaction and the registration request from the service providing server, the first node device generates a first block including the transaction based on a previous block connected to blockchain data stored in a memory of the first node device by a chain, and connects the first block to the blockchain data by the chain to complete storing of the first block, and then propagates the first block to the remaining node devices other than the first node device among the plurality of node devices through the blockchain network.

9. The operating method of claim 6, wherein the conducting certification for the first member includes
maintaining an e-mail storage unit storing information on a predetermined e-mail address for each of the plurality of members,
maintaining a public key storage unit storing a public key corresponding to a private key, wherein the private key for each of the plurality of members is stored in the electronic terminal of each member, pre-issued for each of the plurality of members,
generating a certification event for conducting the certification for the first member when receiving the access request instruction to the tournament session from the first electronic terminal,
randomly generating, when the certification event is generated, a n, wherein n is a natural number of 2 or more, digit first certification number, randomly generating a certification value constituted by a natural number having a size of 9 or less, and then, performing a modulo operation having the certification value as a divisor for respective digit numbers constituting the first certification number to generate an n-digit second certification number,
generating, when the first certification number and the second certification number are generated, a column vector having respective digit numbers constituting the first certification number as components and a row vector having respective digit numbers constituting the second certification number as components, and computing a matrix multiplication between the column vector and the row vector to generate an operation matrix of an n×n size, and then operates Frobenius Norm of the operation matrix,
confirming, when the Frobenius Norm of the operation matrix is computed, a first e-mail address for the first member by referring to the e-mail storage unit, sending a certification e-mail including the first certification number with the first e-mail address as a receiving side, and then transmitting the certification value to the first electronic terminal, and at the same time, requesting an electronic signature based on the first certification number and the certification value, and
extracting, when receiving a first electronic signature value, wherein the first electronic signature value is generated by performing, when the certification value is received in the first electronic terminal, and the first member inputs the first certification number included in the certification e-mail received by an account according to the first e-mail address into the first electronic terminal, by the first electronic terminal, the modulo operation having the certification value as the divisor for the respective digit numbers constituting the first certification number to generate the second certification number, and then generate a column vector having respective digit numbers constituting the first certification number as components and a row vector having respective digit numbers constituting the second certification number as components, and operating the matrix multiplication between the column vector and the row vector to generate the operation matrix, and then signing the Frobenius Norm of the operation matrix with the first private key for the first member stored in the first electronic terminal, from the first electronic terminal in response to the electronic signature request, the first public key for the first member from the public key storage unit, and then comparing a value acquired by decoding the first electronic signature value based on the first public key and the Frobenius Norm of the operation matrix with each other, and when it is confirmed that both values coincide with each other, completing the certification for the first member.

10. The operating method of claim 6, further comprising:
maintaining a price information storage unit storing purchase price information of the ticket for participating in the tournament;
requesting, upon receiving the purchase request instruction of requesting purchasing tickets as many as a first purchase quantity from the first electronic terminal, transmission of payment means information to the first electronic terminal, and upon receiving first payment means information from the first electronic terminal, calculating a price corresponding to the first purchase quantity based on the purchase price information stored in the price information storage unit, and then performing cost payment processing for the calculated price based on the first payment means information; and
increasing, when the cost payment processing is completed, the quantity of holding tickets for the first member stored in the ticket information storage unit by the first purchase quantity.

11. A non-transitory computer readable recording medium having a program recorded therein for allowing a computer to execute an operating method of a service providing server for providing a game service that supports participation in a tournament for a game using a ticket and enables match prediction and betting on members participating in the tournament, comprising:
maintaining a game information storage unit storing information on the number of required tickets for participating in tournaments of a plurality of predetermined respective games;
maintaining a ticket information storage unit storing information on the quantity of holding tickets held by each of a plurality of members which subscribes in the game service;
maintaining a wallet address storage unit storing information on a wallet address for accumulating cryptocurrency held by each of the plurality of members;
maintaining a record information storage unit storing record information of each of the plurality of members for each of the plurality of games, wherein the record information for each of the plurality of games is information in which victory/defeat records in the match for each of the plurality of games of each member are divided and recorded for each game;
conducting, when an access request instruction to a tournament session, wherein the tournament session means a session opened for allowing members accessing to the tournament session through the electronic terminal to play the first game online jointly, opened for a first game which is any one of the plurality of games is received from a first electronic terminal of a first member which is any one of the plurality of members, certification for the first member, and then confirming a first required number which is the number of required tickets for participating in the tournament of the first game by referring to the game information storage unit, and confirming the quantity of holding tickets held by the first member by referring to the ticket information storage unit;
allowing, when it is confirmed that the quantity of holding tickets held by the first member is equal to or more than the first required number, the first electronic terminal to access the tournament session, and then reducing the quantity of holding tickets for the first member stored in the ticket information storage unit by the first required number;
opening, after the access of the first electronic terminal to the tournament session is allowed, when there is a situation in which the first member is matched with a second member who accesses the tournament session to perform a battle for the first game, a betting session for betting on a member who is predicted to win the game between the first member and the second member;
confirming, when a providing request instruction for requesting providing match prediction information in a battle for the first game is received from electronic terminals of a plurality of betting participation members who access the betting session among the plurality of members after the betting session is opened, record information of each of the first member and the second member for the first game by referring to the record information storage unit, and then computing a winning rate of each of the first member and the second member for the first game, and generating the match prediction information based on the winning rate of each of the first member and the second member for the first game, and transmitting the generated match prediction information to the electronic terminals of the plurality of betting participation members;
generating, when the match prediction information is transmitted to the electronic terminals of the plurality of betting participation members, and then a betting request instruction for any one member of the first member and the second member is received from the electronic terminals of the plurality of betting participation members, a betting table in which selection information for a member which each of the plurality of betting participation members selects as a betting target is recorded; and
confirming, after the betting table is generated, when it is determined that the first member wins as a result of performing the battle for the first game, first betting members who bets on the first member among the plurality of betting participation members by referring to the betting table, and then confirming a wallet address of each of the first betting members by referring to the wallet address storage unit, and transferring cryptocurrency corresponding to a predetermined dividend payment amount to the wallet address of each of the first betting members to complete reward processing for the first betting members, and confirming, when it is determined that the second member wins, second betting members who bets on the second member among the plurality of betting participation members by referring to the betting table, and then confirming a wallet address of each of the second betting members by referring to the wallet address storage unit, and then transferring cryptocurrency of the dividend payment amount to the wallet address of each of the second betting members to complete reward processing for the second betting members.
